(19) United States
(12) Patent Application Publication
(10) Pub. No.: US 2008/0048805 A1
(43) Pub. Date: Feb. 28, 2008

(54) Basic Body For A Yig Filter With Eddy Current Suppression

(75) Inventors: Michael Aigle, Sauerlach (DE); Claus Tremmel, Haar (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: RHODE & SCHWARZ GMBH & CO. KG, München (DE)

(21) Appl. No.: 11/667,972

(22) PCT Filed: Nov. 3, 2005
(86) PCT No.: PCT/EP05/11779

§ 371 Date: Sep. 27, 2007

(30) Foreign Application Priority Data
Nov. 22, 2004 (DE) 10 2004 056 256.3

(51) Int. Cl. H01P 7/06

(52) U.S. Cl. 333/228

(57) ABSTRACT

A base body for a YIG bandpass filter configured from a non-magnetic metal and including filter chambers, which are configured in the base body and contain YIG elements. Cavities and/or radial slots are configured in the base body for the suppression of eddy currents.

The invention relates to a basic body for a YIG band-pass filter according to the preamble of claim 1.

YIG band-pass filters have at least one YIG element which has preferably a spherical configuration and is produced from an yttrium-iron-garnet (yttrium-iron-garnet YIG). The resonator effect is provided by means of coupling lines.

A YIG band-pass filter is known for example from the printed publication U.S. Pat. No. 5,294,899. The tunable YIG band-pass filter has thereby a stationary magnetic pole, a rotatable magnetic pole which has a spacing therefrom, an electromagnet for changing the magnetic field between the poles and a plurality of resonators (YIG elements) which are mutually coupled and disposed in the magnetic field between the poles. The number of ferrimagnetic resonators is three or more with respectively one input and output resonator and at least one resonator which is situated therebetween. The rotatable magnetic pole is rotated such that the resonators are tuned to the same resonance frequency by the magnetic field between the two magnetic poles.

It is particularly disadvantageous in the YIG band-pass filter known from the above-mentioned printed publication that eddy currents which delimit the tuning speed are induced in the one-piece basic body of the YIG band-pass filter due to the rapid detuning of the frequency-determining magnetic field which is required for example for spectrum analyzers.

The object of the present invention is accordingly to produce a basic body for a YIG filter which reduces the induction of the eddy currents which are induced in the basic body by the tuning.

The object is achieved with respect to the basic body by the characterizing features of claim 1.

Advantageous developments of the basic body according to the invention are indicated in the sub-claims.

A preferred embodiment of the invention is illustrated by way of example subsequently and described in more detail in the subsequent description. There is shown:

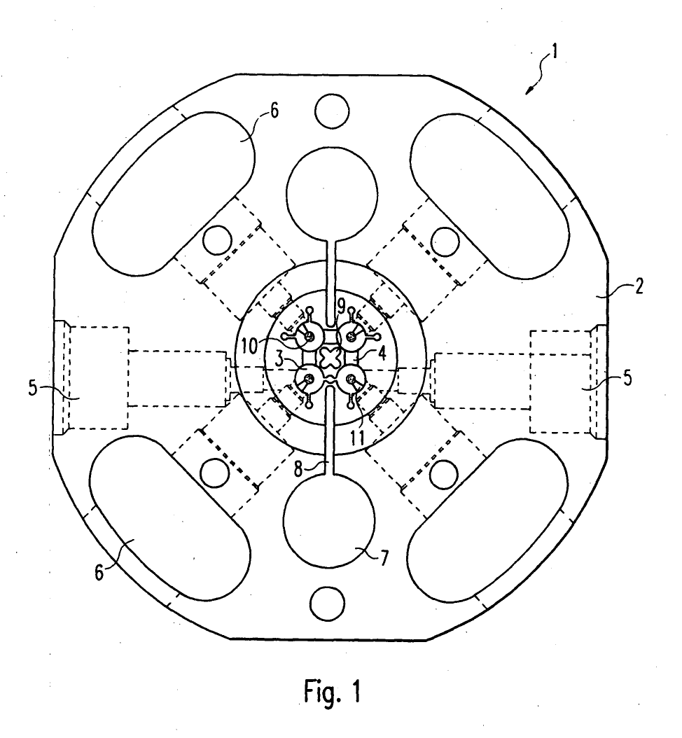

FIG. 1 a schematic plan view of an embodiment of a basic body configured according to the invention of a YIG band-pass filter.

FIG. 1 shows in a schematic plan view an embodiment of a YIG band-pass filter 1, which has a basic body 2 and, in the embodiment, four filter chambers 3 which are configured in the basic body 2 and have the same number of YIG elements 10.

The filter chambers 3 are connected to each other by means of slots 4, in which coupling lines, which are not further represented for reasons of clarity, are inserted and provide the resonator effect between the resonators 10. The number of filter chambers 3 is thereby not restricted to four, but can also be fewer or more.

The YIG band-pass filter 1 includes further components which are independent of the measures according to the invention and hence are only illustrated as an overview. One coupling and decoupling line 5 respectively are disposed situated opposite each other in the basic body 2 in the embodiment. Adjustment devices 6 for the YIG elements 10, which make possible correct positioning of the four YIG elements 10 in this embodiment relative to the coupling lines, are present in the corresponding number. The YIG elements 10 are mounted on retainers 11 which can be adjusted in their position relative to the not-represented coupling lines by means of the adjustment devices 6.

The filter effect of a YIG band-pass filter 1 is based on coupling of the resonators 10 which, during resonance, make it possible to convey energy from the coupling to the decoupling line, however preventing this outside the resonance. The operating frequency of the YIG band-pass filter 1 is substantially determined by the strength of the applied magnetic field.

In order to provide the magnetic field, the YIG elements 10 are situated in the basic body 2 in an airgap of an electromagnet. The basic body 2 thereby is made of a solid non-magnetic metal. This has the advantage of simple mechanical machinability, however, as already mentioned above, the disadvantage that eddy currents can be induced. Furthermore, the metallic basic body 2 serves for the purposes of coupling the individual YIG filter stages by means of as far as possible closed conductive surfaces.

The eddy currents produce a magnetic field which is directed counter to the original magnetic field and hence delimit the tuning speed. Eddy currents in the region of the filter chambers 3 are thereby particularly relevant, since these directly interfere with the frequency-determining field at the location of the YIG elements 10.

In order to eliminate the disadvantages, the basic body 2 according to the invention has recesses 7 and slots 8 connected thereto which serve for suppressing the eddy currents which are induced in the basic body 2 by the rapid tuning of the YIG band-pass filter 1.

The outer recesses 7 are disposed radially outside the filter chambers 3. The slots 8 extend radially outwardly between the filter chambers 3. The recesses 7 have a cross-section which is round, rounded-off or has an oblong hole shape. The outer recesses 7 and the slots 8 connected thereto are configured in the basic body 2 such that an interruption of the eddy currents, in particular in close proximity to the YIG elements 10, is possible. For this purpose, at least one slot 8, in the embodiment two slots 8, is introduced radially from the inside to the outside in the basic body 2, so that an interruption of the closed basic body 2 and hence of the eddy currents is effected in a radially outer region about the YIG elements 10. The outer recesses 7 and the slots 8 intersect in an inner region. Between the filter chambers 3, a further inner recess 9, which has a cross-shaped configuration in the embodiment, is provided, in order to reduce the eddy currents in the radially inner region of the basic body 2.

The outer recesses 7 and the inner recesses 9 and the slots 8 in the basic body 2 are thereby introduced in the complete axial extension thereof, in order to make possible good suppression of the eddy current.

According to the number of filter chambers 3 and the arrangement of the remaining components, basic bodies 2 having a slot 8 or basic bodies 2 having a plurality of slots 8 are possible. Heed merely needs to be paid to the mechanical stability of the basic body 2 for assembly of the individual components.

The invention is not restricted to the represented embodiment and is suitable for any arbitrarily configured YIG band-pass filter 1. The individual features can thereby be combined together in any manner.

1. Basic body (2) for a YIG band-pass filter (1), the basic body (2) being configured from a non-magnetic metal and filter chambers (3) being configured in the basic body (2), YIG elements (10) being disposed in the filter chambers (3),
characterized in that
recesses (7, 9) and/or radial slots (8) for suppressing an eddy current are configured in the basic body (2).

2. Basic body according to claim 1,
characterized in that
the recesses (7, 9) and/or the slots (8) extend across an entire axial thickness of the basic body (2).

3. Basic body according to claim 1 or 2,
characterized in that
the slots (8) extend radially outwards between the filter chambers (3).

4. Basic body according to one of the claims 1 to 3,
characterized in that
the number of recesses (7) and/or of slots (8) is two.

5. Basic body according to one of the claims 1 to 4,
characterized in that
the recesses (7) have a cross-section which is round, rounded-off or has an oblong hole shape.

6. Basic body according to one of the claims 1 to 5,
characterized in that
at least one outer recess (7) is disposed radially outside the filter chambers (3).

7. Basic body according to claim 6,
characterized in that
the outer recesses (7) are configured disposed on the slots (8).

8. Basic body according to one of the claims 1 to 7,
characterized in that
at least one inner recess (9) is disposed between the filter chambers (3).

9. Basic body according to claim 8,
characterized in that
the inner recess (9) has a cross-shaped configuration.
